(19) United States
(12) Patent Application Publication
(10) Pub. No.: US 2003/0132072 A1
(43) Pub. Date: Jul. 17, 2003

(54) Suspension system

(76) Inventors: Seiji Sawai, Shizuoka (JP); Kouji Sakai, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/132,563

(22) Filed: Apr. 25, 2002

(30) Foreign Application Priority Data
Apr. 25, 2001 (JP) 2001-128490

(51) Int. Cl. F16F 9/50

(52) U.S. Cl. 188/281

(57) ABSTRACT

In one embodiment, a suspension system includes a hydraulic assembly. A cylindrical spacer is attached to the hydraulic assembly. An annular seating member is removably coupled to the cylindrical spacer and supports a biasing member. In another embodiment, the annular seating member is coupled to the hydraulic assembly. A support member is removably coupled to the cylindrical assembly.

### RELATED APPLICATIONS

This application is based upon and claims the priority of Japanese Patent Application No. 2001-128490, filed on Apr. 25, 2001, which is hereby incorporated by reference in its entirety.

### BACKGROUND OF THE INVENTION

1. Field of the Invention

The invention relates to a vehicle suspension system and more particularly to a hydraulic shock absorber of the vehicle suspension system.

2. Description of the Related Art

Conventional vehicle suspension systems include at least one hydraulic shock absorber. Each shock absorber typically includes a piston that reciprocates within a hollow cylinder assembly having a first end and a second end. The piston is fixed to one end of a piston rod. The other end of the piston rod typically extends out of a first end of the cylinder and is coupled a portion of the vehicle body. A second end of the cylinder assembly includes a pivot support, which is coupled to a wheel suspension.

The piston is disposed within the internal space of the cylinder assembly to divide the cylinder assembly into first and second chambers. The chambers are typically filled with a fluid such as oil to resist the motion of the piston within the cylinder. The reciprocating movement of the piston is resisted because the fluid must flow through a resistance mechanism when flowing from one chamber to the other chamber. Typically, the resistance mechanism comprises throttle plates or check valves that control the damping of the shock absorber. The movement of the fluid through the resistance mechanism dissipates the input energy to the shock absorber by displacing the fluid through the resistance mechanism. The velocity of the reciprocating piston, which determines the amount of energy dissipated, is controlled by the amount of resistance to the fluid flow.

Typically, the hydraulic shock absorber includes a biasing member (e.g., a spring) for biasing the hydraulic shock absorber to an extended position. In most applications, the biasing member is mounted between the vehicle body and a biasing seat, which is mounted on the cylinder. In this manner, the cylinder is biased away from the vehicle body and the piston is biased to the extended position.

When the hydraulic shock absorber is attached to the vehicle, the piston rod is typically first attached to the body of the vehicle. The biasing member and the biasing seat are then fitted in succession over the pivot support and onto the cylinder. The biasing seat is then secured on the cylinder and the biasing member is fitted between the biasing seat and the vehicle body.

### SUMMARY OF THE INVENTION

For larger vehicles, it may be necessary to increase the size of the pivot support in order to properly support the weight of the vehicle. However, it is generally desirable not to increase the size of the cylinder. Thus, if the size of the pivot portion increases too much, the biasing seat will no longer fit over the pivot portion. This makes attaching the hydraulic shock absorber difficult. A need therefore exists for a suspension system, which can accommodate larger pivot supports without making the assembly of the suspension system difficult.

Accordingly, one aspect of the present invention is a suspension system comprising a cylinder assembly having a first end, a second end, and an inner bore that defines an internal space. A piston is disposed within the internal space to separate the internal space into a first fluid chamber and a second fluid chamber. The piston is coupled to a piston rod which has a first end that extends through the first end of the cylinder assembly. The first end of the piston rod is coupled to a first support member. The second end of the cylinder assembly is coupled to a second support member. An annular seating member has an internal bore configured to fit over the second support member. A spacing member is disposed between and is coupled to the annular seating member and to the cylindrical assembly. A biasing member removably fitted between the first support member and the annular seating member.

Another aspect of the present invention is a hydraulic suspension system that comprises a cylinder assembly having a first end, a second end, and an inner bore that defines an internal space. A piston is disposed within the internal space to separate the internal space into a first fluid chamber and a second fluid chamber. The piston is coupled to a piston rod which has a first end that extends through the first end of the cylinder assembly,. The first end of the piston rod being coupled to a first support member. The second end of the cylinder assembly is removably coupled to a second support member. An annular seating member is removably coupled to the second end of the cylinder assembly, and a biasing member removably fitted between the first support member and the annular seating member.

Yet another aspect of the present invention is a method of attaching a suspension system to a vehicle comprising, coupling a first end of a piston rod that is coupled to a piston disposed within a cylinder assembly, inserting a biasing member over the support member that is coupled to the cylinder assembly and is disposed opposite the first end of the piston rod, inserting an annular seating member over the support member and onto the cylinder assembly, and removably coupling the annular seating member to a cylindrical spacer disposed on the cylinder assembly.

Still yet another aspect of the present invention is a method of forming a hydraulic cylinder for a suspension system comprising forming a piston and a piston rod, the piston being coupled to one end of the piston rod, positioning the piston within a cylinder assembly, and coupling a cylindrical spacer to an outer surface of the cylinder assembly.

Another aspect of the present invention is a method of attaching a suspension system to a vehicle comprising, coupling a first end of a piston rod to the vehicle, inserting a biasing member over a first end of a cylindrical assembly in which a piston is disposed, the piston being coupled to a second end of the piston rod, inserting an annular seating member over the first end of the assembly, removably coupling the annular seating member to the cylindrical assembly, removably coupling a support member to the first end of the cylindrical assembly, and coupling a wheel side member to the support member.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a cross-sectional view of a suspension system having certain features and advantages according to a preferred embodiment of the present invention.

FIG. 2 is an enlarged cross-sectional view of a portion of the suspension system of FIG. 1.

FIG. 3 is a cross-sectional view of a modified suspension system having certain features and advantages according to another embodiment of the present invention.

FIG. 4 is an enlarged cross-sectional view of a portion of the suspension system of FIG. 3.

FIG. 5 is a cross-sectional view of another modified suspension system having certain features and advantages according to an additional embodiment of the present invention

FIG. 6 is an enlarged cross-sectional view of a portion of the suspension system of FIG. 5.

### DETAILED DESCRIPTION OF THE PREFERRED EMBODIMENT

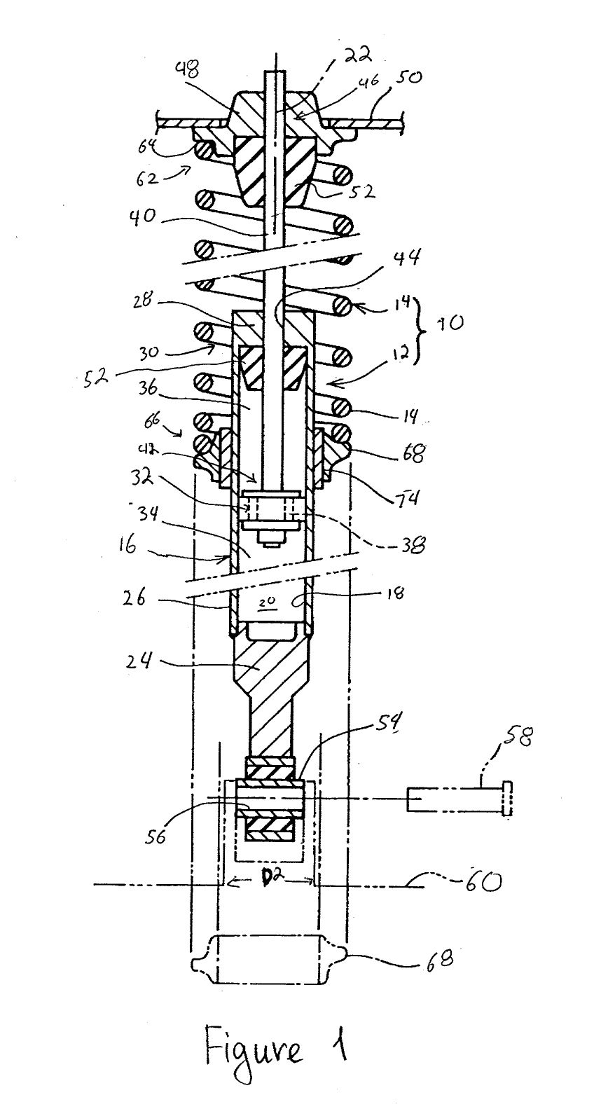

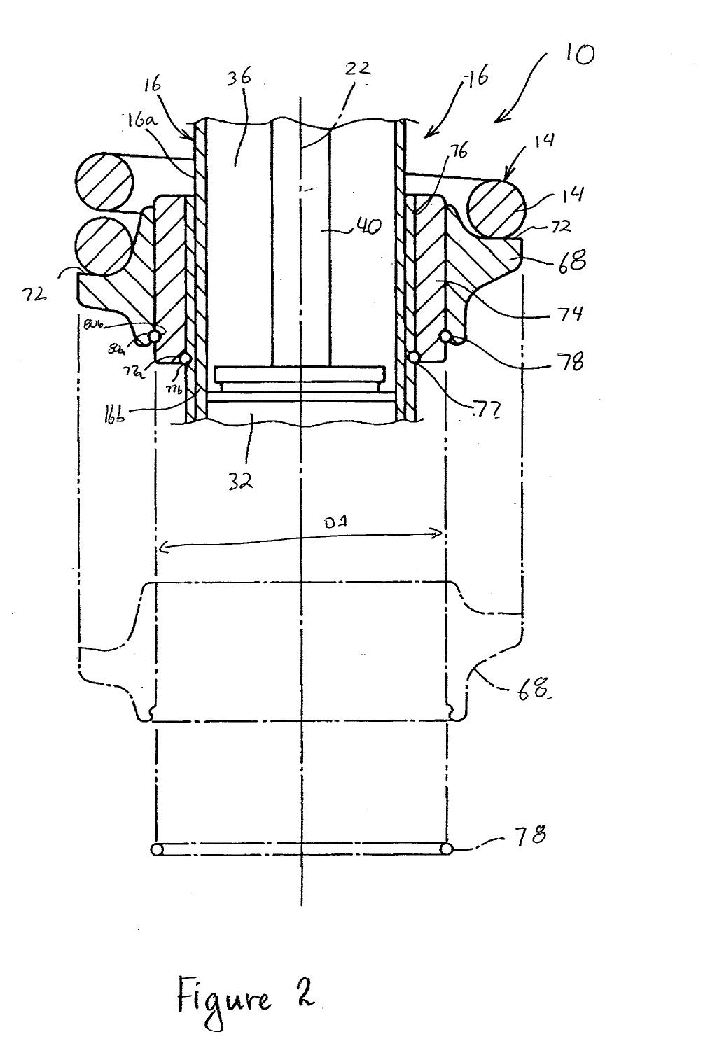

FIG. 1 illustrates a suspension system 10 having certain features and advantages according to an embodiment of the present invention. The suspension system 10 generally comprises a cylinder assembly 12 and a biasing member 14, which in the illustrated embodiment comprises a coiled spring. The cylinder assembly 12 comprises a cylindrical tube 16 that defines a cylinder bore 18 and an internal chamber 20. In a modified embodiment, which is illustrated in FIG. 2, the cylindrical tube can be doubled walled (i.e., formed from a first part 16a and a second part 16b). The cylindrical tube 16 in the illustrated application is centered about a longitudinal axis 22 that extends in a generally vertical direction. The cylinder assembly 12 further comprises a cover piece 24, which is coupled to a lower end 26 of the cylindrical tube 16, and a piston rod guide 28, which can be coupled to an upper end 30 of the cylindrical tube 16 or be formed in the upper end 30 of the cylindrical tube as shown in the illustrated embodiment. In the illustrated embodiment, the cylindrical tube 16 has a generally constant outside diameter.

A piston 32 is positioned in the internal chamber 20 and divides the internal chamber 20 into a first chamber 34 and a second chamber 36. The first and second chambers 34, 36 are sealed from each other by seals (not shown) carried by the piston 32. A control valve or control passage 38 is preferably provided in the piston 32 for permitting a controlled amount of fluid flow between the first and second chambers 34, 36. In a modified embodiment, the control valve or passage can be provided in a bypass passage that extend between the two chambers 34, 36.

A piston rod 40 has a first or lower end 42 coupled to the piston 32. The piston rod 40 extends through the second chamber 36 and a bore 44 formed in the piston rod guide 28. A second or upper end 46 of the piston rod 40 is coupled to a support member 48, which is attached to the body 50 of a vehicle. The piston rod 40 preferably extends generally along the longitudinal axis 22 of the cylindrical tube 16. In the illustrated embodiment, rubber stops 52 are provided in the cylindrical tube 16 and on the support member 48 to prevent damage caused by extreme movement of the piston 32 or the cylindrical tube 16.

The cover piece 24 is coupled to a pivot support member 54. The pivot support member 54 defines a pivot bore 56 that is configured for receiving a pivot pin 58. The pivot pin 58 is used to secure a wheel side support member 60 to the pivot support member 54. In this manner, the cylinder assembly 12 is secured between the body 50 of the vehicle and a wheel side support member 60 of the vehicle. More specifically, in the illustrated embodiment, the piston rod 40 is coupled to the body 50 of the vehicle while the cylindrical tube 16 is coupled to the wheel side support member 60. However, it should be appreciated that this arrangement can be reversed. That is, the piston rod 40 can be coupled to the wheel side support member 60 while the cylindrical tube 16 is coupled to the body 50 of the vehicle.

The biasing member 14 has a first end 62 that abuts against the support member 48, which in the illustrated embodiment, defines an annular seat 64 for the biasing member 14. In modified embodiments, the first end 62 can also be coupled to the support member 48. An opposite end or second end 66 of the biasing member 14 is coupled to an annular seating member 68 that is, in turn, coupled to the cylindrical tube 16 as will be explained in more detail below with reference to FIG. 2.

As shown in FIG. 2, the annular seating member 68 defines an inner bore 70, which has a first diameter D1. The annular seating member 68 also defines an annular flange 72 for supporting the biasing member 14. Advantageously, the diameter D1 of the inner bore 70 is significantly larger than a maximum diameter D2 of the pivot support 54 (see FIG. 1). As will be explained in more detail below, this arrangement allows the annular seating member 68 to be inserted over several different sizes of pivot supports 54.

A cylindrical spacing member 74 is positioned between the inner bore 70 of the annular seating member 68 and an outer surface 76 of the cylindrical tube 16, which in the illustrated embodiment is of a double walled construction comprising a first piece 16a and a second piece 16b. The cylindrical spacing member 74 has an inner diameter that is slightly larger than the outside diameter of the cylindrical tube 16. In the illustrated embodiment, the cylindrical spacing member 74 is removably supported on the cylindrical tube 16 by a first retaining ring 77. The cylindrical spacing member 74 and the cylindrical tube 16 include corresponding annular notches 79a, 79b for receiving the first retaining ring 77.

The cylindrical spacing member 74 has an outside diameter that is slightly smaller than the inside diameter D2 of the annular seating member 68. In the illustrated embodiment, the annular seating member 68 is also removably secured to the cylindrical spacing member 74 by a second retaining ring 78. As such, the cylindrical spacing member 74 and the annular seating member 68 preferably include corresponding annular notches 80a, 80b for receiving the second retaining ring 78.

With the biasing member 14 secured between the annular seating member 68 and the body 50 of the vehicle, the cylindrical tube 16 is biased away from the body 50 of the vehicle. That is, the piston 32 is forced into an extended position.

The cylindrical spacer 74 is preferably coupled to the cylindrical tube 16 when the cylindrical assembly 12 is constructed. In one embodiment, the cylindrical spacer 74 is inserted onto the tube 16 before the cover piece 24 is attached to the cylindrical tube 16. In this manner, the cylindrical spacer 74 is not affected by the size of the pivot support member 54. To attach the suspension system 10 to the vehicle, the second end 46 of the piston rod 40 is first attached to the body 50 through the support member 48. The biasing member 14 and the annular seating member 68 are then moved in succession from a first position, which is outside the pivot support member 54 as shown in phantom lines in FIGS. 1 and 2, to a second position wherein the annular seating member 64 is positioned over the cylindrical spacer 74, as shown in the solid lines of FIGS. 1 and 2. The annular seating member 68 can now be secured to the cylindrical spacer by the retaining ring 78 (also shown in phantom in FIGS. 1 and 2) so that the biasing member 14 is secured between the support member 48 and the annular seating member 68. Finally, the pivot support member 54 can be attached to the wheel side member 60 by the pivot pin 58.

The illustrated arrangement has several advantages. For example, because the inner bore of the annular seating member 68 has a diameter D1 that is significantly larger than the maximum diameter D2 of the pivot support member 54, the size of the pivot support member 54 can be increased without adversely affecting the assembly of the suspension system 10. In addition, if the biasing member 14 becomes damaged, the biasing member 14 can be easily removed by uncoupling the annular seating member 68 from the cylindrical spacer 74. The annular seating member 68 can be then be removed over the larger pivot support 54 and the biasing member 14 can be removed. A new or repaired biasing member 14 can then be installed as described above.

In a modified embodiment, the cylindrical spacer 74 is secured to the cylindrical tube 16 by cooperating threads formed on the outside of the cylindrical tube 16 and on the inner bore of the cylindrical spacer 74. In another embodiment, the cylindrical spacer 74 is secured to the cylindrical tube 16 by one or more set screws. Both of these embodiments have an additional advantage in that the position of the cylindrical spacer 74 along the axis 22 of the cylindrical tube 16 can be adjusted. This adjustability permits the initial biasing force of the biasing member 14 to be adjusted. In another modified embodiment, the cylindrical spacing member 74 can be formed from a plurality of arcuate members that are placed around the cylindrical tube 16 and to the cylindrical tube 16 secured by a series of welds.

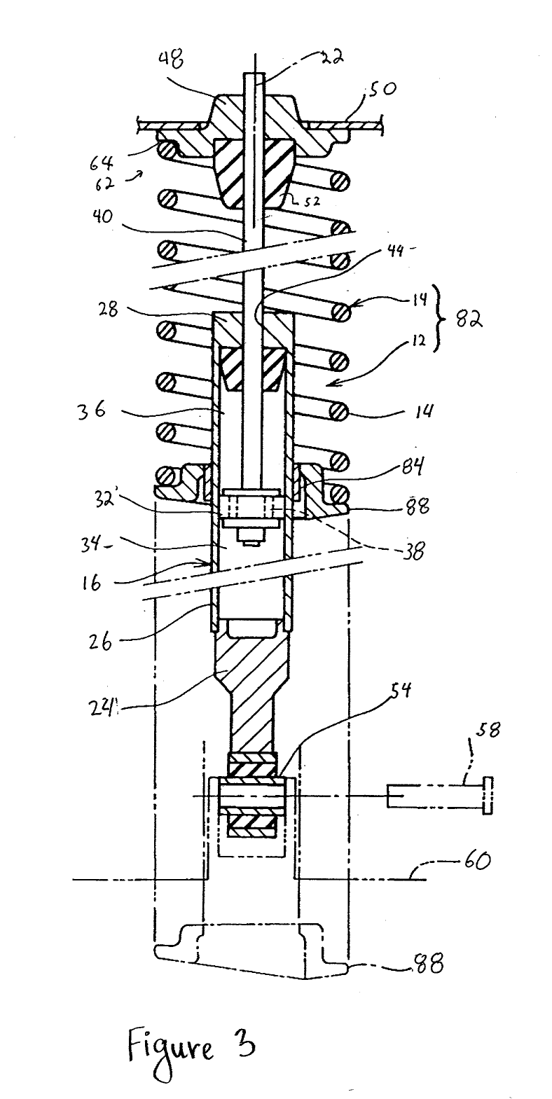

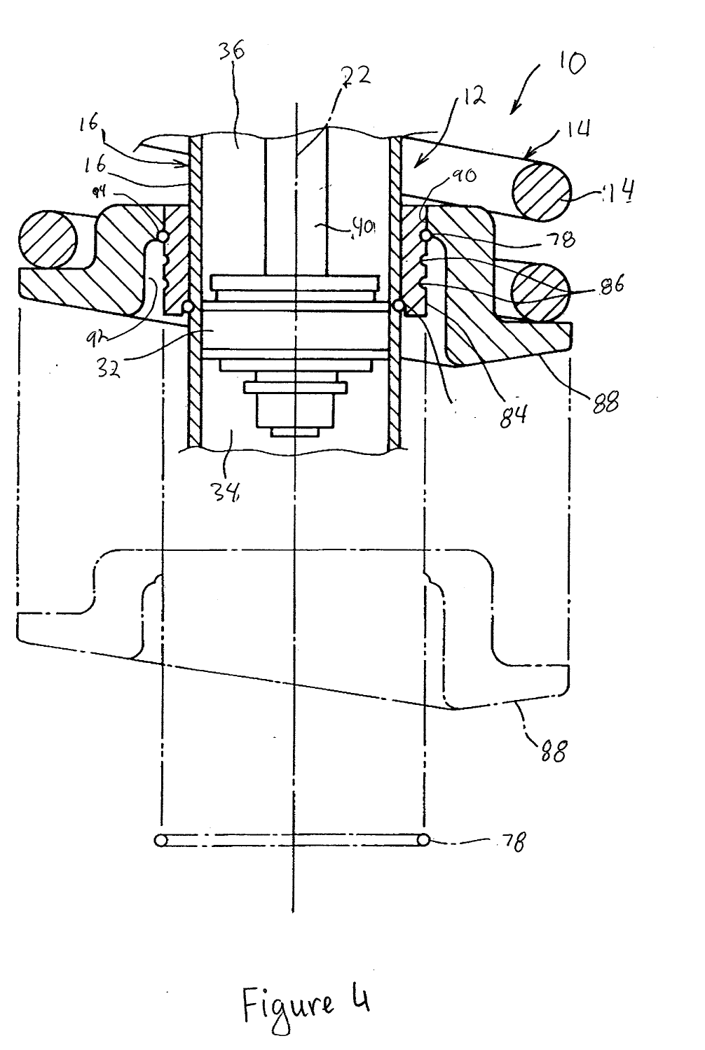

FIGS. 3 and 4 illustrate an additional embodiment of a suspension system 82 wherein like numbers are used to refer to parts that are substantially similar to those of FIGS. 1 and 2. In this embodiment, a modified cylindrical spacer 84 is provided with a plurality of annular notches 86. The plurality of notches 86 provide several spaces into which the second retaining ring 78 can be inserted to secure a modified annular seating member 88 to the cylindrical spacer 84. In addition, in the illustrated embodiment, the inner bore 90 of the annular seating member 88 includes a recessed portion 92, which terminates at a corresponding notch 94 for the second retaining ring 78. In a modified embodiment, the annular seating member can be formed without the recessed portion 92.

This arrangement also provides the suspension system 82 with adjustability. That is, the position of the annular seating member 88 with respect to the cylindrical tube 16 can be adjusted by using one of the plurality of notches 86 on the cylindrical spacer 84. In this manner, the initial biasing force of the biasing member 14 can be adjusted. In addition, the recessed portion 92 shields the second retaining ring 78. This prevents the second retaining ring 78 from becoming damaged so that it can be more easily removed. In a modified embodiment, the annular seating member 88 can be provided with a plurality of notches for receiving the retaining ring 78 and adjusting the position of the annular seating member 88 on the cylindrical tube 16.

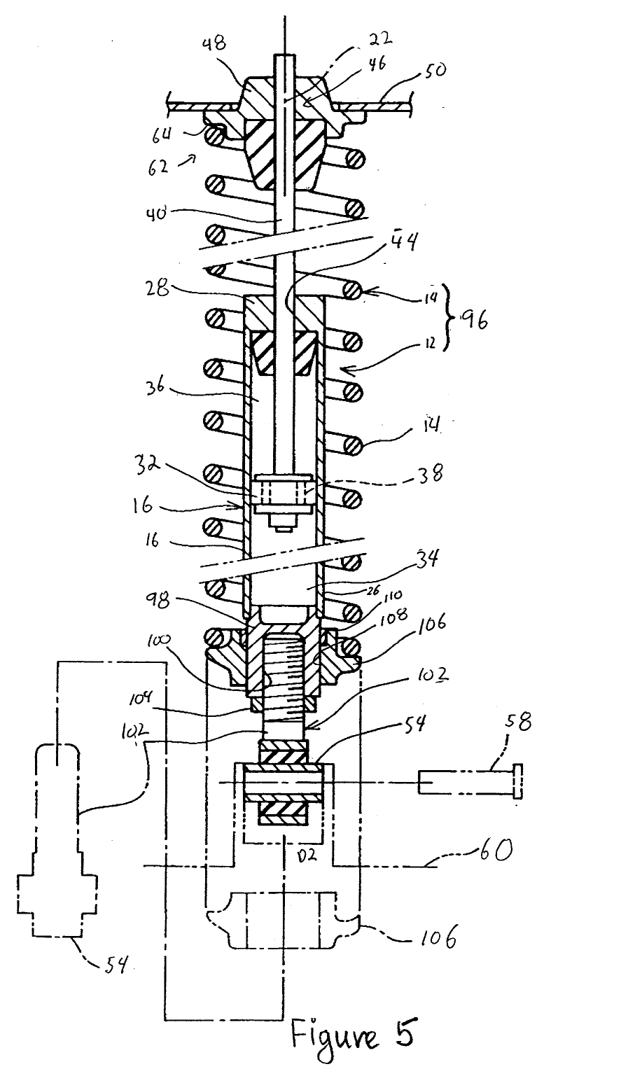

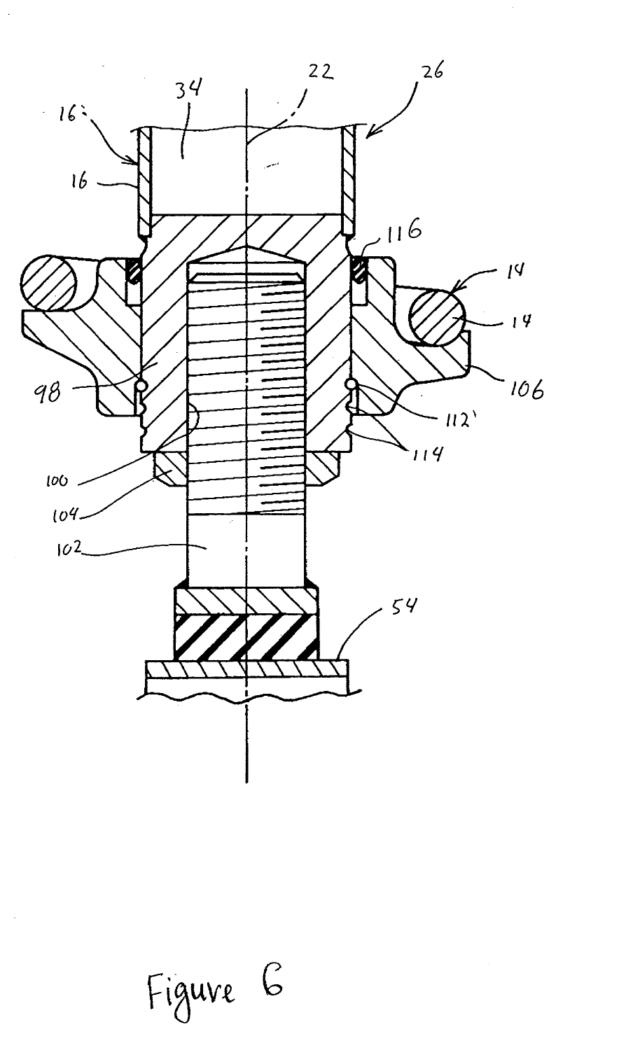

FIGS. 5 and 6 illustrate an additional modified embodiment of a suspension system 96 wherein like numbers are used to refer to parts substantially similar to those of FIGS. 1 and 2. In this embodiment, a modified cover piece 98 includes a bore 100, which is at least partially threaded and is centered about the longitudinal axis 22. The pivot support 54 is attached to a shaft 102, which is at least partially threaded and is configured to fit within the threaded bore 100 of the cover piece 98. Preferably, a nut 104 is also provided for securing the threaded shaft 102 to the cover piece 98. In a modified embodiment, the bore 100 and the shaft 102 can include complementary flattened or smooth portions. In this manner, the shaft 102 can be inserted into the bore 100 with no or minimal rotation and then rotated to lock the shaft 102 into the bore. The shaft 102 can be removed 100 by rotating the shaft to align the complementary flattened portions so that the shaft 102 can be withdrawn without rotation.

In the illustrated embodiment, a modified annular seating member 106 is directly attached to the cover piece 98. As such, the annular seating member 106 preferably has an internal bore 108 with a diameter that is slightly larger than the outside diameter of the cover piece 98. As will be explained below, the internal bore 108 does not need to have a diameter that is significantly larger than the diameter D2 of the pivot support member 54. The annular seating member 106 can be attached to the cover piece 98 in a variety of ways. In the illustrated embodiment as is best seen in FIG. 6, the annular seating member 106 is coupled to the cover piece 98 using a retainer ring 112. The cover head 98 includes a plurality of notches 114, which provide several spaces into which the retaining ring 112 can be inserted to secure the annular seating member 106 to the cover piece 98. This arrangement provides the suspension system 96 with adjustability. That is, the position of the annular seating member 106 with respect to the cylindrical tube 16 can be adjusted by using one of the plurality of notches 114. In this manner, the initial biasing force of the biasing member 14 can be adjusted. In the illustrated embodiment, an O-ring 166 provides additional support for a tight fit between the annular seating member 106 and the cover piece 98. In a modified embodiment, the annular seating member 106 can include a plurality of notches 114 for receiving the retaining ring 112 and adjusting the position of the annular seating member 106 with respect to the cylindrical tube 16.

To attach the suspension system 96 to the vehicle, the second end 46 of the piston rod 40 is attached to the vehicle body 50 through the support member 48. The pivot support 54 is removed by loosening the nut 104 and unthreading the shaft 102 from the cover piece 98. The biasing member 14 and the annular seating member 106 are then moved in succession from a first position, which is shown in phantom lines in FIG. 5, to a second position wherein the annular seating 106 member is positioned over the cover piece 98 as shown in the solid lines of FIG. 5. The annular seating member 106 can now be secured to the cover piece 98 using the retaining ring 112. The pivot support 54 can then be attached to the cover piece 98 by threading the threaded shaft 102 into the threaded bore 100 and securing the nut 104. Finally, the pivot support 54 an be attached to the wheel side member 60 by the pivot pin 58. If the biasing member becomes damaged, the pivot support 54 can be removed by loosening the nut 104 and unthreading the shaft 102 from the cover piece 98. The annular seating member 106 can now be removed and the biasing member 14 can be replaced.

As with the previous embodiments, the size of the pivot support 54 can be increased without having to modify the shape and size of the annular seating member 106. In this arrangement, this flexibility is achieved by detachably coupling the pivot support 54 to the cover piece 98.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. For example, it is contemplated that various combination or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed:

1. A hydraulic suspension system comprising a cylinder assembly having a first end, a second end, and an inner bore that defines an internal space, a piston disposed within the internal space to separate the internal space into a first fluid chamber and a second fluid chamber, the piston coupled to a piston rod which has a first end that extends through the first end of the cylinder assembly, the first end of the piston rod being coupled to a first support member, the second end of the cylinder assembly being coupled to a second support member, an annular seating member having an internal bore configured to fit over the second support member, a spacing member disposed between and coupled to the annular seating member and to the cylindrical assembly, and a biasing member removably fitted between the first support member and the annular seating member.

2. A hydraulic suspension system as in claim 1, wherein the second support member comprises a pivot support adapted to be coupled to a wheel side member by a pivot pin.

3. A hydraulic suspension system as in claim 2, wherein the first support member is configured to be coupled to a body member of a vehicle.

4. A hydraulic suspension system as in claim 1, wherein the spacing member is a cylindrical tube.

5. A hydraulic suspension system as in claim 1, wherein the spacing member is coupled to the annular seating member by a first retaining ring and the spacing member and the annular seating member include a pair of corresponding notches for receiving the first retaining ring.

6. A hydraulic suspension system as in claim 1, wherein the spacing member includes plurality of notches in which to receive the first retaining ring.

7. A hydraulic suspension system as in claim 1, wherein the spacing member is coupled to the cylindrical assembly by a second retaining member, and the spacing member and the cylindrical assembly include a second pair of notches for receiving the second retaining ring.

8. A hydraulic suspension system as in claim 1, wherein the piston defines a control passage for restricting the flow of fluid between first fluid chamber and the second fluid chamber upon movement of the piston relative to the cylinder assembly,

9. A hydraulic suspension system comprising a cylinder assembly having a first end, a second end, and an inner bore that defines an internal space, a piston is disposed within the internal space to separate the internal space into a first fluid chamber and a second fluid chamber, the piston coupled to a piston rod which has a first end that extends through the first end of the cylinder assembly, the first end of the piston rod being coupled to a first support member, the second end of the cylinder assembly being removably coupled to a second support member, an annular seating member removably coupled to the second end of the cylinder assembly, and a biasing member removably fitted between the first support member and the annular seating member.

10. A hydraulic suspension system as in claim 9, wherein the second support member comprises a pivot support that is configured to be coupled to a wheel side member by a pivot pin.

11. A hydraulic suspension system as in claim 10, wherein the first support member is configured to be coupled to a body member of a vehicle.

12. A hydraulic suspension system as in claim 9, wherein the second end of the cylinder assembly includes a bore that is at least partially threaded and the second support member is coupled to a shaft that is at least partially threaded and is configured to be removably inserted into the bore.

13. A hydraulic suspension system as in claim 12, wherein the annular seating member is coupled to the second end of the cylinder assembly by a retaining ring, the annular seating member and the second end of the cylinder assembly including a pair of corresponding notches for receiving the retaining ring.

14. A hydraulic suspension system as in claim 13, wherein the second end of the cylinder assembly includes plurality of notches in which to receive the retaining ring.

15. A hydraulic suspension system as in claim 9, the piston defining a control passage for restricting the flow of fluid between first fluid chamber and the second fluid chamber upon movement of the piston relative to the cylinder assembly,

16. A method of attaching a suspension system to a vehicle comprising, coupling a first end of a piston rod that is coupled to a piston disposed within a cylinder assembly, inserting a biasing member over the support member that is coupled to the cylinder assembly and is disposed opposite the first end of the piston rod, inserting an annular seating member over the support member and onto the cylinder assembly, and removably coupling the annular seating member to a cylindrical spacer disposed on the cylinder assembly.

17. A method as in claim 16, comprising coupling the support member to a wheel side member.

18. A method of forming a hydraulic cylinder for a suspension system comprising forming a piston and a piston rod, the piston being coupled to one end of the piston rod, positioning the piston within a cylinder assembly, and coupling a cylindrical spacer to an outer surface of the cylinder assembly.

19. A method of attaching a suspension system to a vehicle comprising, coupling a first end of a piston rod to the vehicle, inserting a biasing member over a first end of a cylindrical assembly in which a piston is disposed, the piston being coupled to a second end of the piston rod, inserting an annular seating member over the first end of the assembly, removably coupling the annular seating member to the cylindrical assembly, removably coupling a support member to the first end of the cylindrical assembly, and coupling a wheel side member to the support member.
